(19) United States
(12) Patent Application Publication
(10) Pub. No.: US 2013/0264060 A1
(43) Pub. Date: Oct. 10, 2013

(54) FLUID SUITABLE FOR TREATMENT OF CARBONATE FORMATIONS CONTAINING A CHELATING AGENT

(71) Applicants: Cornelia Adriana De Wolf, Eerbeek (NL); Hisham Nasr-El-Din, College Station, TX (US); Mohamed Ahmed Nasr-El-Din Mahmoud, Dhahran (SA); James N. Lepage, Chicago, IL (US); Johanna Hendrika Bemelaar, Deventer (NL); Albertus Jacobus Maria Bouwman, Groessen (NL); Guanqun Wang, College Station, TX (US)

(72) Inventors: Cornelia Adriana De Wolf, Eerbeek (NL); Hisham Nasr-El-Din, College Station, TX (US); Mohamed Ahmed Nasr-El-Din Mahmoud, Dhahran (SA); James N. Lepage, Chicago, IL (US); Johanna Hendrika Bemelaar, Deventer (NL); Albertus Jacobus Maria Bouwman, Groessen (NL); Guanqun Wang, College Station, TX (US)

(73) Assignee: AKZO NOBEL CHEMICALS INTERNATIONAL B.V., Amersfoort (NL)

(21) Appl. No.: 13/993,539

(22) PCT Filed: Dec. 16, 2011
(86) PCT No.: PCT/EP2011/073042

§ 371 Date: Jun. 12, 2013

Related U.S. Application Data
(60) Provisional application No. 61/424,271, filed on Dec. 17, 2010.
(60) Provisional application No. 61/496,145, filed on Jun. 13, 2011.

(30) Foreign Application Priority Data
Jan. 21, 2011 (EP) 11151728.0
Dec. 14, 2011 (EP) PCT/EP2011/072696

(51) Int. Cl. C09K 8/74; E21B 37/06

(52) U.S. Cl. CPC C09K 8/74; E21B 37/06
USPC 166/305.1; 507/241; 507/240

(57) ABSTRACT

The present invention covers a fluid and kit of parts suitable for treating carbonate formations containing glutamic acid N,N-diacetic acid or a salt thereof (GLDA) and/or methylglycine N,N-diacetic acid or a salt thereof (MGDA), a corrosion inhibitor, and a surfactant, and the use thereof.

The present invention relates to fluids containing glutamic acid N,N-diacetic acid or a salt thereof (GLDA) and/or methylglycine N,N-diacetic acid or a salt thereof (MGDA) that are suitable to treat carbonate formations.

Subterranean formations from which oil and/or gas can be recovered can contain several solid materials contained in porous or fractured rock formations. The naturally occurring hydrocarbons, such as oil and/or gas, are trapped by the overlying rock formations with lower permeability. The reservoirs are found using hydrocarbon exploration methods and often one of the purposes of withdrawing the oil and/or gas therefrom is to improve the permeability of the formations. The rock formations can be distinguished by their major components, and one category is formed by the so-called carbonate formations, which contain carbonates as the major constituent (like calcite and dolomite). Another category is formed by the so-called sandstone formations, which contain siliceous materials as the major constituent.

In a few documents the use of GLDA in acidizing carbonate formations is disclosed.

Mahmoud M. A., Nasr-el-Din, H. A., De Wolf, C. A., LePage, J. N., Bemelaar, J. H., in “Evaluation of a New Environmentally Friendly Chelating Agent for High-Temperature Applications,” presented at the SPE International Symposium on Formation Damage Control, Lafayette, La., 10-12 Feb. 2010, published as SPE 127923, disclose the use of GLDA to dissolve calcium from carbonate rocks and to form wormholes. In this document aqueous formulations containing GLDA and optionally NaCl are disclosed.

LePage, J. N., De Wolf, C. A., Bemelaar, J. H., Nasr-el-Din, H. A., in “An Environmentally Friendly Stimulation Fluid for High-Temperature Applications,” presented at the SPE International Symposium on Oilfield Chemistry, The Woodlands, Tex., 20-22 Apr. 2009, published as SPE 121709, disclose that GLDA has a good capacity for dissolving calcite and that it is highly soluble in acidic solutions. In addition, it is disclosed that GLDA is less corrosive than HCl but that a corrosion inhibitor still needs to be added at high temperatures.

Mahmoud M. A., Nasr-el-Din, H. A., De Wolf, C. A., LePage, J. N., in “Optimum Injection Rate Of A New Chelate That Can Be Used To Stimulate Carbonate Reservoirs,” presented at the SPE Annual Technical Conference and Exhibition, Florence, Italy, 20-22 Sep. 2010, published as SPE 133497, disclose the use of GLDA to create wormholes by carbonate acidizing. The document only discloses aqueous formulations of GLDA that optionally contain additional NaCl. In addition, it is suggested that fluids containing GLDA of a pH of 3.8 do not need a breaker, crosslinker, diverting agent or mutual solvent because GLDA at pH 3.8 is able to divert the flow.

Further investigations have now been carried out directed at the optimization of fluids containing GLDA and/or MGDA that are suitable for treating carbonate formations. This has led to further improved fluids containing GLDA and/or MGDA that are suitable for use in treating carbonate formations, as well as kits of parts containing a fluid with GLDA and/or MGDA that are suitable for the same. The term treating in this application is intended to cover any treatment of the formation with the fluid. It specifically covers treating the carbonate formation with the fluid to achieve at least one of (i) an increased permeability, (ii) the removal of small particles, and (iii) the removal of inorganic scale, and so enhance the well performance and enable an increased production of oil and/or gas from the formation. At the same time it may cover cleaning of the wellbore and descaling of the oil/gas production well and production equipment.

The present invention now provides fluids containing glutamic acid N,N-diacetic acid or a salt thereof (GLDA) and/or methylglycine N,N-diacetic acid or a salt thereof (MGDA), a corrosion inhibitor, and a surfactant. The amount of GLDA and/or MGDA is preferably up to 30 wt %, based on the total weight of the fluid.

Moreover, the present invention relates to a kit of parts for a treatment process consisting of several stages, such as the pre-flush, main treatment and postflush stage, wherein one part of the kit of parts for one stage of the treatment process, contains a fluid containing glutamic acid N,N-diacetic acid or a salt thereof (GLDA) and/or methylglycine N,N-diacetic acid or a salt thereof (MGDA), and a corrosion inhibitor, and the other part of the kit of parts for the other stage of the treatment process, contains a surfactant, or wherein one part contains a fluid containing GLDA and/or MGDA and a corrosion inhibitor, and the other part contains a mutual solvent and a surfactant. A pre- or post-flush is a fluid stage pumped into the formation prior to or after the main treatment. The purposes of the pre- or post-flush include but are not limited to adjusting the wettability of the formation, displacing formation brines, adjusting the salinity of the formation, dissolving calcareous material and dissolving iron scales. Such a kit of parts can be conveniently used in the process of the invention, wherein the part containing a fluid containing a surfactant and, in one embodiment, a mutual solvent is used as a preflush and/or postflush fluid and the other part containing a fluid containing GLDA and a corrosion inhibitor is used as the main treatment fluid.

The invention in addition provides the use of the above fluids and kits of parts in treating a subterranean carbonate formation to increase the permeability thereof, remove small particles therefrom and/or remove inorganic scale therefrom and so enhance the production of oil and/or gas from the formation, and/or in cleaning of the wellbore and/or descaling of the oil/gas production well and production equipment in the production of oil and/or gas from a subterranean carbonate formation. When the kit of parts of the present invention is used in treating a subterranean carbonate formation to increase the permeability thereof, remove small particles therefrom and/or remove inorganic scale therefrom, the fluid from the one part of the kit is introduced into the carbonate formation for the main treatment step and that of the other part for the preflush and/or postflush step.

Contrary to earlier disclosures, the fluids contain, besides an effective amount of GLDA and/or MGDA, both a corrosion inhibitor and a surfactant. Surprisingly, it was found that in these fluids there is a good balance of properties. The fluids and kits of parts allow a very efficient treatment of the carbonate formations to make them more permeable and so enable the withdrawal of oil and or gas therefrom. At the same time, the fluids and the kits of parts give few undesired side effects such as fracturing of the formation when used at the optimal injection rate, precipitation of salts and small particles leading to plugging of the formation, and corrosion. Also without the addition of any viscosifier the fluids and kits of parts of the invention have a favourable viscosity build-up, i.e. the viscosity of the fluids increases during the use thereof. Also, the fluids of the invention can be effective without needing a full amount of mutual solvent to transport the oil and/or gas from the formation, as it has been found that with the addition of a small amount of surfactant a fluid containing GLDA and/or MGDA can already transport oil and/or gas in an acceptable amount. The fluids and kits of parts of the invention have a prolonged activity and lead to a decreased surface spending and as such avoid face dissolution and therefore act deeper in the formation. At the same time, it was found that in the fluid and kits of parts of the invention the presence of GLDA and/or MGDA ensures that smaller amounts of some usual additives such as corrosion inhibitors, corrosion inhibitor intensifiers, anti sludge agents, iron control agents, scale inhibitors are needed to achieve a similar effect to that of state of the art stimulation fluids, reducing the chemicals burden of the process and creating a more sustainable way to produce oil and/or gas. Under some conditions some of these additives are even completely redundant. The components were also surprisingly compatible with each other, also at the temperatures encountered in an oil and/or gas production well, which may be up to 400° F. (about 204° C.), and at relatively acidic and basic pH.

In this respect, reference is made to S. Al-Harthy et al. in “Options for High-Temperature Well Stimulation,” Oilfield Review Winter 2008/2009, 20, No. 4, where the use of trisodium N-hydroxyethyl ethylenediamine N,N′,N′-triacetic acid (HEDTA) is disclosed to have much lower undesired corrosion side effects than a number of other chemical materials, like HCl and mud acid, that play a role in the oil industry wherein the use of chromium steel is common practice.

Besides it being found that the use of cationic surfactants such as preferred in the present invention can already decrease the undesired corrosivity of fluids in the oil and gas industry, it has now in addition been found that over the whole pH range from 3 to 13 GLDA and MGDA give an even lower corrosion of chromium-containing materials than HEDTA, especially in the relevant low pH range from 3 to 7, in the case of GLDA even below the industry limit value of 0.05 lbs/sq.ft (for a 6 hour test period), without the addition of any corrosion inhibitors. Accordingly, the invention covers a fluid and kit of parts containing MGDA and/or GLDA that gives an unexpectedly reduced chromium corrosion side effect, and the use thereof in a carbonate formation treatment process wherein corrosion of the chromium-containing equipment is significantly prevented, and an improved process to clean and/or descale chromium-containing equipment. Also because of the above beneficial effect, the invention covers fluids and kits of parts in which the amount of corrosion inhibitor and corrosion inhibitor intensifier can be greatly reduced compared to the state of the art fluids and processes, while still avoiding corrosion problems in the equipment.

As a further benefit it was found that the fluids and kits of parts of the present invention, which in many embodiments are water-based, perform as well in an oil saturated environment as in an aqueous environment. This can only lead to the conclusion that the fluids and kits of parts of the invention are extremely compatible with (crude) oil.

The surfactant can be any surfactant known to the person skilled in the art for use in oil and gas wells. Preferably, the surfactant is a nonionic or cationic surfactant, even more preferably a cationic surfactant.

The GLDA and/or MGDA are preferably present in the fluid or in the fluid in the kit of parts in an amount of between 5 and 30 wt %, even more preferably of between 10 and 20 wt % on total fluid.

Salts of GLDA and/or MGDA that can be used are their alkali metal, alkaline earth metal, or ammonium full and partial salts. Also mixed salts containing different cations can be used. Preferably, the sodium, potassium, and ammonium full or partial salts of GLDA and/or MGDA are used.

In a preferred embodiment the fluids of the invention (also the fluids in the kits of parts) contain GLDA, as these fluids were found to give the better permeability enhancement.

The fluids of the invention (also the fluids in the kits of parts) are preferably aqueous fluids, i.e. they preferably contain water as a solvent for the other ingredients, wherein water can be e.g. fresh water, produced water or seawater, though other solvents may be added as well, as further explained below.

In an embodiment, the pH of the fluids of the invention and the fluids in the kits of parts of the invention can range from 1.7 to 14. Preferably, however, it is between 3.5 and 13, as in the very acidic ranges of 1.7 to 3.5 and the very alkaline range of 13 to 14, some undesired side effects may be caused by the fluids in the formation, such as too fast dissolution giving excessive CO₂ formation or an increased risk of reprecipitation. For a better carbonate dissolving capacity it is preferably acidic. On the other hand, it must be realized that highly acidic solutions are more expensive to prepare. Consequently, the solution even more preferably has a pH of 3.5 to 8.

The fluids and the kits of parts of the invention may be free of, but preferably contain more than 0 wt % up to 2 wt %, more preferably 0.1-1 wt %, even more preferably 0.1-0.5 wt %, of corrosion inhibitor. The fluids may be free of, but preferably contain more than 0 and up to 2 wt % of surfactant, more preferably 0.1-2 wt %, even more preferably 0.1-1 volume %, each amount being based upon the total weight or volume of the fluid.

When using the fluids and kits of parts of the invention in treating a subterranean carbonate formation to increase the permeability thereof, remove small particles therefrom and/or remove inorganic scale therefrom and so enhance the production of oil and/or gas from the formation, or in cleaning of the wellbore and/or descaling of the oil/gas production well and production equipment in the production of oil and/or gas from a subterranean carbonate formation, the fluid is preferably used at a temperature of between 35 and 400° F. (about 2 and 204° C.), more preferably between 77 and 400° F. (about 25 and 204° C.), even more preferably between 77 and 300° F. (about 25 and 149° C.), most preferably between 150 and 300° F. (about 65 and 149° C.).

The use of the fluids and kits of parts in the treatment of carbonate formations is preferably at a pressure between atmospheric pressure and fracture pressure, wherein fracture pressure is defined as the pressure above which injection of fluids will cause the formation to fracture hydraulically.

The fluids (also the fluids in the kits of parts) may contain other additives that improve the functionality of the stimulation action and minimize the risk of damage as a consequence of the said treatment, as is known to anyone skilled in the art.

The fluid of the invention (also the fluids in the kits of parts) may in addition contain one or more additives from the group of mutual solvents, anti-sludge agents, (water-wetting or emulsifying) surfactants, corrosion inhibitor intensifiers, foaming agents, viscosifiers, wetting agents, diverting agents, oxygen scavengers, carrier fluids, fluid loss additives, friction reducers, stabilizers, rheology modifiers, gelling agents, scale inhibitors, breakers, salts, brines, pH control additives such as further acids and/or bases, bactericides/biocides, particulates, crosslinkers, salt substitutes (such as tetramethyl ammonium chloride), relative permeability modifiers, sulfide scavengers, fibres, nanoparticles, combinations thereof, or the like.

The embodiments wherein a bactericide or biocide is added to the fluid are preferred. In combination with a biocide or bactericide the GLDA and/or MGDA reduces the number of and sometimes even fully removes the bacteria that are responsible for the formation of sulfides from sulfate. As iron forms a precipitate with sulfide, also in this way iron control takes place. Also, sulfides are not only a problem when they combine with Fe to give insoluble FeS precipitates, but also when they form H₂S, which is toxic and corrosive. It has even been found that the combination of GLDA and/or MGDA with a biocide or bactericide is synergistic, i.e. less biocide or bactericide is required to control the growth of microorganisms in the presence of GLDA and/or MGDA, reducing the negative environmental effect of using large quantities of biocides or bactericides with their inherent negative eco-tox profile.

The mutual solvent is a chemical additive that is soluble in oil, water, acids (often HCl based), and other well treatment fluids. Mutual solvents are routinely used in a range of applications, controlling the wettability of contact surfaces before, during and/or after a treatment, and preventing or breaking emulsions. Mutual solvents are used, as insoluble formation fines pick up organic film from crude oil. These particles are partially oil-wet and partially water-wet. This causes them to collect materials at any oil-water interface, which can stabilize various oil-water emulsions. Mutual solvents remove organic films leaving them water-wet, thus emulsions and particle plugging are eliminated. If a mutual solvent is employed, it is preferably selected from the group which includes, but is not limited to, lower alcohols such as methanol, ethanol, 1-propanol, 2-propanol, and the like, glycols such as ethylene glycol, propylene glycol, diethylene glycol, dipropylene glycol, polyethylene glycol, polypropylene glycol, polyethylene glycol-polyethylene glycol block copolymers, and the like, and glycol ethers such as 2-methoxyethanol, diethylene glycol monomethyl ether, and the like, substantially water/oil-soluble esters, such as one or more C2-esters through C10-esters, and substantially water/oil-soluble ketones, such as one or more C2-C10 ketones, wherein substantially soluble means soluble in more than 1 gram per liter, preferably more than 10 grams per liter, even more preferably more than 100 grams per liter, most preferably more than 200 grams per liter. The mutual solvent is preferably present in an amount of 1 to 50 wt % on total fluid.

A preferred water/oil-soluble ketone is methyl ethyl ketone.

A preferred substantially water/oil-soluble alcohol is methanol.

A preferred substantially water/oil-soluble ester is methyl acetate.

A more preferred mutual solvent is ethylene glycol monobutyl ether, generally known as EGMBE

The amount of glycol solvent in the solution is preferably about 1 wt % to about 10 wt %, more preferably between 3 and 5 wt %. More preferably, the ketone solvent may be present in an amount from 40 wt % to about 50 wt %; the substantially water-soluble alcohol may be present in an amount within the range of about 20 wt % to about 30 wt %; and the substantially water/oil-soluble ester may be present in an amount within the range of about 20 wt % to about 30 wt %, each amount being based upon the weight of the solvent system.

The surfactant can be any surfactant known in the art and can be nonionic, cationic, anionic, zwitterionic, but as indicated above, preferably, the surfactant is nonionic or cationic and even more preferably, the surfactant is cationic.

The nonionic surfactant of the present composition is preferably selected from the group consisting of alkanolamides, alkoxylated alcohols, alkoxylated amines, amine oxides, alkoxylated amides, alkoxylated fatty acids, alkoxylated fatty amines, alkoxylated alkyl amines (e.g., cocoalkyl amine ethoxylate), alkyl phenyl polyethoxylates, lecithin, hydroxylated lecithin, fatty acid esters, glycerol esters and their ethoxylates, glycol esters and their ethoxylates, esters of propylene glycol, sorbitan, ethoxylated sorbitan, polyglycosides and the like, and mixtures thereof. Alkoxylated alcohols, preferably ethoxylated alcohols, optionally in combination with (alkyl) polyglycosides, are the most preferred nonionic surfactants.

The cationic surfactants may comprise quaternary ammonium compounds (e.g., trimethyl tallow ammonium chloride, trimethyl coco ammonium chloride), derivatives thereof, and combinations thereof.

Examples of surfactants that are also foaming agents that may be utilized to foam and stabilize the treatment fluids of this invention include, but are not limited to, betaines, amine oxides, methyl ester sulfonates, alkylamidobetaines such as cocoamidopropyl betaine, alpha-olefin sulfonate, trimethyl tallow ammonium chloride, C8 to C22 alkyl ethoxylate sulfate, and trimethyl coco ammonium chloride.

Suitable surfactants may be used in a liquid or powder form.

Where used, the surfactants may be present in the fluid in an amount sufficient to prevent incompatibility with formation fluids, other treatment fluids, or wellbore fluids at reservoir temperature.

In an embodiment where liquid surfactants are used, the surfactants are generally present in an amount in the range of from about 0.01% to about 5.0% by volume of the fluid.

In one embodiment, the liquid surfactants are present in an amount in the range of from about 0.1% to about 2.0% by volume of the fluid, preferably from 0.1 to 1.0 volume %.

In embodiments where powdered surfactants are used, the surfactants may be present in an amount in the range of from about 0.001% to about 0.5% by weight of the fluid.

The antisludge agent can be chosen from the group of mineral and/or organic acids that are used to stimulate limestone, or dolomite. The function of the acid is to dissolve acid-soluble materials so as to clean or enlarge the flow channels of the formation leading to the wellbore, allowing more oil and/or gas to flow to the wellbore.

Problems are caused by the interaction of the (usually concentrated, 20-28%) stimulation acid and certain crude oils (e.g. aphaltic oils) in the formation to form sludge. Interaction studies between sludging crude oils and the introduced acid show that permanent rigid solids are formed at the acid-oil interface when the aqueous phase is below a pH of about 4. No films are observed for non-sludging crudes with acid.

These sludges are usually reaction products formed between the acid and the high molecular weight hydrocarbons such as asphaltenes, resins, etc.

Methods for preventing or controlling sludge formation with its attendant flow problems during the acidization of crude-containing formations include adding “anti-sludge” agents to prevent or reduce the rate of formation of crude oil sludge, which anti-sludge agents stabilize the acid-oil emulsion and include alkyl phenols, fatty acids, and anionic surfactants. Frequently used as the surfactant is a blend of a sulfonic acid derivative and a dispersing surfactant in a solvent. Such a blend generally has dodecyl benzene sulfonic acid (DDBSA) or a salt thereof as the major dispersant, i.e. anti-sludge, component.

The carrier fluids are aqueous solutions which in certain embodiments contain a Bronsted acid to keep the pH in the desired range and/or contain an inorganic salt, preferably NaCl.

Corrosion inhibitors may be selected from the group of amine and quaternary ammonium compounds and sulfur compounds. Examples are diethyl thiourea (DETU), which is suitable up to 185° F. (about 85° C.), alkyl pyridinium or quinolinium salt, such as dodecyl pyridinium bromide (DDPB), and sulfur compounds, such as thiourea or ammonium thiocyanate, which are suitable for the range 203-302° F. (about 95-150° C.), benzotriazole (BZT), benzimidazole (BZI), dibutyl thiourea, a proprietary inhibitor called TIA, and alkyl pyridines.

In general, the most successful inhibitor formulations for organic acids and chelating agents contain amines, reduced sulfur compounds or combinations of a nitrogen compound (amines, quats or polyfunctional compounds) and a sulfur compound.

The amount of corrosion inhibitor is preferably between 0.1 and 2.0 volume %, more preferably between 0.1 and 1.0 volume % on total fluid.

One or more corrosion inhibitor intensifiers may be added, such as for example formic acid, potassium iodide, antimony chloride, or copper iodide.

One or more salts may be used as rheology modifiers to modify the rheological properties (e.g., viscosity and elastic properties) of the treatment fluids. These salts may be organic or inorganic.

Examples of suitable organic salts include, but are not limited to, aromatic sulfonates and carboxylates (such as p-toluene sulfonate and naphthalene sulfonate), hydroxynaphthalene carboxylates, salicylate, phthalate, chlorobenzoic acid, phthalic acid, 5-hydroxy-1-naphthoic acid, 6-hydroxy-1-naphthoic acid, 7-hydroxy-1-naphthoic acid, 1-hydroxy-2-naphthoic acid, 3-hydroxy-2-naphthoic acid, 5-hydroxy-2-naphthoic acid, 7-hydroxy-2-naphthoic acid, 1,3-dihydroxy-2-naphthoic acid, 3,4-dichlorobenzoate, trimethyl ammonium hydrochloride and tetramethyl ammonium chloride.

Examples of suitable inorganic salts include water-soluble potassium, sodium, and ammonium halide salts (such as potassium chloride and ammonium chloride), calcium chloride, calcium bromide, magnesium chloride, sodium formate, potassium formate, cesium formate, and zinc halide salts. A mixture of salts may also be used, but it should be noted that preferably chloride salts are mixed with chloride salts, bromide salts with bromide salts, and formate salts with formate salts.

Wetting agents that may be suitable for use in this invention include crude tall oil, oxidized crude tall oil, surfactants, organic phosphate esters, modified imidazolines and amidoamines, alkyl aromatic sulfates and sulfonates, and the like, and combinations or derivatives of these and similar such compounds that should be well known to one of skill in the art.

The foaming gas may be air, nitrogen or carbon dioxide. Nitrogen is preferred.

Gelling agents in a preferred embodiment are polymeric gelling agents.

Examples of commonly used polymeric gelling agents include, but are not limited to, biopolymers, polysaccharides such as guar gums and derivatives thereof, cellulose derivatives, synthetic polymers like polyacrylamides and viscoelastic surfactants, and the like. These gelling agents, when hydrated and at a sufficient concentration, are capable of forming a viscous solution.

When used to make an aqueous-based treatment fluid, a gelling agent is combined with an aqueous fluid and the soluble portions of the gelling agent are dissolved in the aqueous fluid, thereby increasing the viscosity of the fluid.

Viscosifiers may include natural polymers and derivatives such as xantham gum and hydroxyethyl cellulose (HEC) or synthetic polymers and oligomers such as poly(ethylene glycol) [PEG], poly(diallyl amine), poly(acrylamide), poly(aminomethyl propyl sulfonate) [AMPS polymer], poly(acrylonitrile), poly(vinyl acetate), poly(vinyl alcohol), poly(vinyl amine), poly(vinyl sulfonate), poly(styryl sulfonate), poly(acrylate), poly(methyl acrylate), poly(methacrylate), poly(methyl methacrylate), poly(vinyl pyrrolidone), poly(vinyl lactam), and co-, ter-, and quater-polymers of the following (co-)monomers: ethylene, butadiene, isoprene, styrene, divinyl benzene, divinyl amine, 1,4-pentadiene-3-one (divinyl ketone), 1,6-heptadiene-4-one (diallyl ketone), diallyl amine, ethylene glycol, acrylamide, AMPS, acrylonitrile, vinyl acetate, vinyl alcohol, vinyl amine, vinyl sulfonate, styryl sulfonate, acrylate, methyl acrylate, methacrylate, methyl methacrylate, vinyl pyrrolidone, and vinyl lactam. Yet other viscosifiers include clay-based viscosifiers, especially laponite and other small fibrous clays such as the polygorskites (attapulgite and sepiolite). When using polymer-containing viscosifiers, the viscosifiers may be used in an amount of up to 5% by weight of the fluid.

Examples of suitable brines include calcium bromide brines, zinc bromide brines, calcium chloride brines, sodium chloride brines, sodium bromide brines, potassium bromide brines, potassium chloride brines, sodium nitrate brines, sodium formate brines, potassium formate brines, cesium formate brines, magnesium chloride brines, sodium sulfate, potassium nitrate, and the like. A mixture of salts may also be used in the brines, but it should be noted that preferably chloride salts are mixed with chloride salts, bromide salts with bromide salts, and formate salts with formate salts.

The brine chosen should be compatible with the formation and should have a sufficient density to provide the appropriate degree of well control.

Additional salts may be added to a water source, e.g., to provide a brine, and a resulting treatment fluid, in order to have a desired density.

The amount of salt to be added should be the amount necessary for formation compatibility, such as the amount necessary for the stability of clay minerals, taking into consideration the crystallization temperature of the brine, e.g., the temperature at which the salt precipitates from the brine as the temperature drops.

Preferred suitable brines may include seawater and/or formation brines.

Salts may optionally be included in the fluids of the present invention for many purposes, including for reasons related to compatibility of the fluid with the formation and the formation fluids.

To determine whether a salt may be beneficially used for compatibility purposes, a compatibility test may be performed to identify potential compatibility problems.

From such tests, one of ordinary skill in the art will, with the benefit of this disclosure, be able to determine whether a salt should be included in a treatment fluid of the present invention.

Suitable salts include, but are not limited to, calcium chloride, sodium chloride, magnesium chloride, potassium chloride, sodium bromide, potassium bromide, ammonium chloride, sodium formate, potassium formate, cesium formate, and the like. A mixture of salts may also be used, but it should be noted that preferably chloride salts are mixed with chloride salts, bromide salts with bromide salts, and formate salts with formate salts.

The amount of salt to be added should be the amount necessary for the required density for formation compatibility, such as the amount necessary for the stability of clay minerals, taking into consideration the crystallization temperature of the brine, e.g., the temperature at which the salt precipitates from the brine as the temperature drops.

Salt may also be included to increase the viscosity of the fluid and stabilize it, particularly at temperatures above 180° F. (about 82° C.).

Examples of suitable pH control additives which may optionally be included in the treatment fluids of the present invention are acid compositions and/or bases.

A pH control additive may be necessary to maintain the pH of the treatment fluid at a desired level, e.g., to improve the effectiveness of certain breakers and to reduce corrosion on any metal present in the wellbore or formation, etc.

One of ordinary skill in the art will, with the benefit of this disclosure, be able to recognize a suitable pH for a particular application.

In one embodiment, the pH control additive may be an acid composition.

Examples of suitable acid compositions may comprise an acid, an acid-generating compound, and combinations thereof.

Any known acid may be suitable for use with the treatment fluids of the present invention.

Examples of acids that may be suitable for use in the present invention include, but are not limited to, organic acids (e.g., formic acids, acetic acids, carbonic acids, citric acids, glycolic acids, lactic acids, ethylene diamine tetraacetic acid (“EDTA”), hydroxyethyl ethylene diamine triacetic acid (“HEDTA”), and the like), inorganic acids (e.g., hydrochloric acid, and the like), and combinations thereof. Preferred acids are HCl and organic acids.

Examples of acid-generating compounds that may be suitable for use in the present invention include, but are not limited to, esters, aliphatic polyesters, ortho esters, which may also be known as ortho ethers, poly(ortho esters), which may also be known as poly(ortho ethers), poly(lactides), poly(glycolides), poly(epsilon-caprolactones), poly(hydroxybutyrates), poly(anhydrides), or copolymers thereof.

Derivatives and combinations also may be suitable.

The term “copolymer” as used herein is not limited to the combination of two polymers, but includes any combination of polymers, e.g., terpolymers and the like.

Other suitable acid-generating compounds include: esters including, but not limited to, ethylene glycol monoformate, ethylene glycol diformate, diethylene glycol diformate, glyceryl monoformate, glyceryl diformate, glyceryl triformate, methylene glycol diformate, and formate esters of pentaerythritol.

The pH control additive also may comprise a base to elevate the pH of the fluid.

Generally, a base may be used to elevate the pH of the mixture to greater than or equal to about 7.

Having the pH level at or above 7 may have a positive effect on a chosen breaker being used and may also inhibit the corrosion of any metals present in the wellbore or formation, such as tubing, screens, etc.

In addition, having a pH greater than 7 may also impart greater stability to the viscosity of the treatment fluid, thereby enhancing the length of time that viscosity can be maintained.

This could be beneficial in certain uses, such as in longer-term well control and in diverting.

Any known base that is compatible with the gelling agents of the present invention can be used in the fluids of the present invention.

Examples of suitable bases include, but are not limited to, sodium hydroxide, potassium carbonate, potassium hydroxide, sodium carbonate, and sodium bicarbonate.

One of ordinary skill in the art will, with the benefit of this disclosure, recognize the suitable bases that may be used to achieve a desired pH elevation.

In some embodiments, the treatment fluid may optionally comprise a further chelating agent.

When added to the treatment fluids of the present invention, the chelating agent may chelate any dissolved iron (or other divalent or trivalent cation) that may be present in the aqueous fluid and prevent any undesired reactions being caused.

Such chelating may e.g. prevent such ions from crosslinking the gelling agent molecules.

Such crosslinking may be problematic because, inter alia, it may cause filtration problems, injection problems, and/or again cause permeability problems.

Any suitable chelating agent may be used with the present invention.

Examples of suitable chelating agents include, but are not limited to, citric acid, nitrilotriacetic acid (“NTA”), any form of ethylene diamine tetraacetic acid (“EDTA”), hydroxyethyl ethylene diamine triacetic acid (“HEDTA”), diethylene triamine pentaacetic acid (“DTPA”), propylene diamine tetraacetic acid (“PDTA”), ethylene diamine-N,N″-di(hydroxyphenylacetic) acid (“EDDHA”), ethylene diamine-N,N″-di-(hydroxy-methylphenyl acetic acid (“EDDHMA”), ethanol diglycine (“EDG”), trans-1,2-cyclohexylene dinitrilotetraacetic acid (“CDTA”), glucoheptonic acid, gluconic acid, sodium citrate, phosphonic acid, salts thereof, and the like.

In some embodiments, the chelating agent may be a sodium or potassium salt.

Generally, the chelating agent may be present in an amount sufficient to prevent undesired side effects of divalent or trivalent cations that may be present, and thus also functions as a scale inhibitor.

One of ordinary skill in the art will, with the benefit of this disclosure, be able to determine the proper concentration of a chelating agent for a particular application.

As indicated, in some preferred embodiments, the fluids of the present invention may contain bactericides or biocides, inter alia, to protect the subterranean formation as well as the fluid from attack by bacteria. Such attacks can be problematic because they may lower the viscosity of the fluid, resulting in poorer performance, such as poorer sand suspension properties, for example.

Any bactericides known in the art are suitable. In one embodiment, biocides and bactericides that protect against bacteria that may attack GLDA or MGDA or sulfates are preferred.

An artisan of ordinary skill will, with the benefit of this disclosure, be able to identify a suitable bactericide and the proper concentration of such bactericide for a given application.

Examples of suitable bactericides and/or biocides include, but are not limited to, phenoxyethanol, ethylhexyl glycerine, benzyl alcohol, methyl chloroisothiazolinone, methyl isothiazolinone, methyl paraben, ethyl paraben, propylene glycol, bronopol, benzoic acid, imidazolinidyl urea, a 2,2-dibromo-3-nitrilopropionamide, and a 2-bromo-2-nitro-1,3-propane diol. In one preferred embodiment, the bactericides/biocides are present in the fluid in an amount in the range of from about 0.001% to about 1.0% by weight of the fluid.

The fluids of the present invention also may comprise breakers capable of reducing the viscosity of the fluid at a desired time.

Examples of such suitable breakers for fluids of the present invention include, but are not limited to, oxidizing agents such as sodium chlorites, sodium bromate, hypochlorites, perborate, persulfates, and peroxides, including organic peroxides.

Other suitable breakers include, but are not limited to, suitable acids and peroxide breakers, triethanol amine, as well as enzymes that may be effective in breaking. The breakers can be used as is or encapsulated.

Examples of suitable acids may include, but are not limited to, hydrochloric acid, hydrofluoric acid, formic acid, acetic acid, citric acid, lactic acid, glycolic acid, etc. A breaker may be included in a treatment fluid of the present invention in an amount and form sufficient to achieve the desired viscosity reduction at a desired time.

The breaker may be formulated to provide a delayed break, if desired.

The fluids of the present invention also may comprise suitable fluid loss additives. Such fluid loss additives may be particularly useful when a fluid of the present invention is used in a fracturing application or in a fluid used to seal a formation against invasion of fluid from the wellbore.

Any fluid loss agent that is compatible with the fluids of the present invention is suitable for use in the present invention.

Examples include, but are not limited to, starches, silica flour, gas bubbles (energized fluid or foam), benzoic acid, soaps, resin particulates, relative permeability modifiers, degradable gel particulates, diesel or other hydrocarbons dispersed in fluid, and other immiscible fluids.

Another example of a suitable fluid loss additive is one that comprises a degradable material.

Suitable examples of degradable materials include polysaccharides such as dextran or cellulose; chitins; chitosans; proteins; aliphatic polyesters; poly(lactides); poly(glycolides); poly(glycolide-co-lactides); poly(epsilon-caprolactones); poly(3-hydroxybutyrates); poly(3-hydroxybutyrate-co-hydroxyvalerates); poly(anhydrides); aliphatic poly(carbonates); poly(ortho esters); poly(amino acids); poly(ethylene oxides); poly(phosphazenes); derivatives thereof; or combinations thereof.

In some embodiments, a fluid loss additive may be included in an amount of about 5 to about 2,000 lbs/Mgal (about 600 to about 240,000 g/Mliter) of the fluid.

In some embodiments, the fluid loss additive may be included in an amount from about 10 to about 50 lbs/Mgal (about 1,200 to about 6,000 g/Mliter) of the fluid.

In certain embodiments, a stabilizer may optionally be included in the fluids of the present invention.

It may be particularly advantageous to include a stabilizer if a chosen fluid is experiencing viscosity degradation.

One example of a situation where a stabilizer might be beneficial is where the BHT (bottom hole temperature) of the wellbore is sufficient to break the fluid by itself without the use of a breaker.

Suitable stabilizers include, but are not limited to, sodium thiosulfate, methanol, and salts such as formate salts and potassium or sodium chloride.

Such stabilizers may be useful when the fluids of the present invention are utilized in a subterranean formation having a temperature above about 200° F. (about 93° C.). If included, a stabilizer may be added in an amount of from about 1 to about 50 lbs/Mgal (about 120 to about 6,000 g/Mliter) of fluid.

Scale inhibitors may be added to the fluids of the present invention, for example, when such fluids are not particularly compatible with the formation waters in the formation in which they are used.

These scale inhibitors may include water-soluble organic molecules with carboxylic acid, aspartic acid, maleic acids, sulfonic acids, phosphonic acid, and phosphate ester groups including copolymers, ter-polymers, grafted copolymers, and derivatives thereof.

Examples of such compounds include aliphatic phosphonic acids such as diethylene triamine penta (methylene phosphonate) and polymeric species such as polyvinyl sulfonate.

The scale inhibitor may be in the form of the free acid but is preferably in the form of mono and polyvalent cation salts such as Na, K, Al, Fe, Ca, Mg, NH₄. Any scale inhibitor that is compatible with the fluid in which it will be used is suitable for use in the present invention.

Suitable amounts of scale inhibitors that may be included in the fluids of the present invention may range from about 0.05 to 100 gallons per about 1,000 gallons (i.e. 0.05 to 100 liters per 1,000 liters) of the fluid.

Any particulates such as fibres that are commonly used in subterranean operations in carbonate formations may be used in the present invention, as may polymeric materials, such as polyglycolic acids and polylactic acids.

It should be understood that the term “particulate” as used in this disclosure includes all known shapes of materials including substantially spherical materials, oblong, fibre-like, ellipsoid, rod-like, polygonal materials (such as cubic materials), mixtures thereof, derivatives thereof, and the like.

In some embodiments, coated particulates may be suitable for use in the treatment fluids of the present invention. It should be noted that many particulates also act as diverting agents. Further diverting agents are viscoelastic surfactants and in-situ gelled fluids.

Oxygen scavengers may be needed to enhance the thermal stability of the GLDA or MGDA. Examples thereof are sulfites and ethorbates.

Friction reducers can be added in an amount of up to 0.2 vol %. Suitable examples are viscoelastic surfactants and enlarged molecular weight polymers.

Crosslinkers can be chosen from the group of multivalent cations that can crosslink polymers such as Al, Fe, B, Ti, Cr, and Zr, or organic crosslinkers such as polyethylene amides, formaldehyde.

Sulfide scavengers can suitably be an aldehyde or ketone.

Viscoelastic surfactants can be chosen from the group of amine oxides or carboxyl butane based surfactants.

The fluids and kit of parts can be used at basically any temperature that is encountered when treating a subterranean formation. The fluids are preferably used at a temperature of between 35 and 400° F. (about 2 and 204° C.). More preferably, the fluids are used at a temperature where they best achieve the desired effects, which means a temperature of between 77 and 300° F. (about 25 and 149° C.).

High temperature applications may benefit from the presence of an oxygen scavenger in an amount of less than about 2 volume percent of the solution.

At the same time the fluids and kits of parts can be used at an increased pressure. Often fluids are pumped into the formation under pressure. Preferably, the pressure used is below fracture pressure, i.e. the pressure at which a specific formation is susceptible to fracture. Fracture pressure can vary a lot depending on the formation treated, but is well known by the person skilled in the art.

The fluids can be flooded back from the formation and in some embodiments can be recycled.

It must be realized, however, that MGDA and GLDA, being biodegradable chelating agents, will not completely flow back and therefore they are not recyclable to the full extent.

### EXAMPLE 1

A beaker glass was filled with 400 ml of a solution of a chelating agent as indicated in Table 1 below, i.e. about 20 wt % of the monosodium salt of about pH 3.6. This beaker was placed in a Burton Corblin 1 liter autoclave.

The space between the beaker and the autoclave was filled with sand. Two clean steel coupons of Cr13 (UNS S41000 steel) were attached to the autoclave lid with a PTFE cord. The coupons were cleaned with isopropyl alcohol and weighted before the test. The autoclave was purged three times with a small amount of N₂. Subsequently the heating was started or in the case of high-pressure experiments, the pressure was first set to c. 1,000 psi with N₂. The 6-hour timer was started directly after reaching a temperature of 149° C. After 6 hours at 149° C. the autoclave was cooled quickly with cold tap water in c. 10 minutes to <60° C. After cooling to <60° C. the autoclave was depressurized and the steel coupons were removed from the chelate solution. The coupons were flushed with a small amount of water and isopropyl alcohol to clean them. The coupons were weighted again and the chelate solution was retained. HEDTA and GLDA were obtained from AkzoNobel Functional Chemicals BV. MGDA was obtained from BASF Corporation.

TABLE 1
Acid/Chelate solutions:

| | Active ingredient and | |
|---|---|---|
| Chelate | content | pH as such |
| GLDA | 20.4 wt % GLDA-NaH₃ | 3.51 |
| HEDTA | 22.1 wt % HEDTA-NaH₂ | 3.67 |
| MGDA | 20.5 wt % MGDA-NaH₂ | 3.80 |

In the scheme of Table 2 the results of the corrosion study of 13Cr steel coupons (UNS S41000) are shown for the different solutions.

TABLE 2
Different chelate or acid solutions

| | | | | | | 6 Hrs |
|---|---|---|---|---|---|---|
| | | | Temp. | Pressure | Assay after | corrosion |
| Test no. | Chelate | pH | ° C. | (PSI) | corrosion test | lbs/sq. ft |
| #01 | GLDA | 3.5 | 160 | — | 18.4 wt % as | 0.0013 |
| | | | | | GLDA-NaH₃ | |
| #02 | GLDA | 3.5 | 149 | — | 20.1 wt % as | 0.0008 |
| | | | | | GLDA-NaH₃ | |
| #03 | HEDTA | 3.7 | 149 | — | 24.4 wt % as | 0.3228 |
| | | | | | HEDTA-NaH₂ | |
| #04 | GLDA | 3.5 | 149 | >1,000 | 20.1 wt % as | 0.0009 |
| | | | | | GLDA-NaH₃ | |
| #05 | HEDTA | 3.7 | 149 | >1,000 | 16.0 wt % as | 0.5124 |
| | | | | | HEDTA-NaH₂ | |
| #06 | MGDA | 3.6 | 149 | >1,000 | 22.7 wt % as | 0.0878 |
| | | | | | MGDA-NaH₂ | |

The corrosion rates of HEDTA at 149° C. and pressure 1000 psi are significantly higher than those of MGDA and much higher compared to GLDA. The corrosion rates of both HEDTA and MGDA at 149° C. and pressure 1000 psi are higher than the generally accepted limit value in the oil and gas industry of 0.05 lbs/sq.ft (6-hour test period), which means that they will need a corrosion inhibitor for use in this industry. As MGDA is significantly better than HEDTA, it will require a much decreased amount of corrosion inhibitor for acceptable use in the above applications when used in line with the conditions of this Example. The 6-hour corrosion of GLDA for 13Cr steel (stainless steel S410, UNS 41000) at 149° C. (300° F.) is well below the generally accepted limit value in the oil and gas industry of 0.05 lbs/sq.ft. It can thus be concluded that it is possible to use GLDA in this field without the need to add a corrosion inhibitor.

### EXAMPLE 2

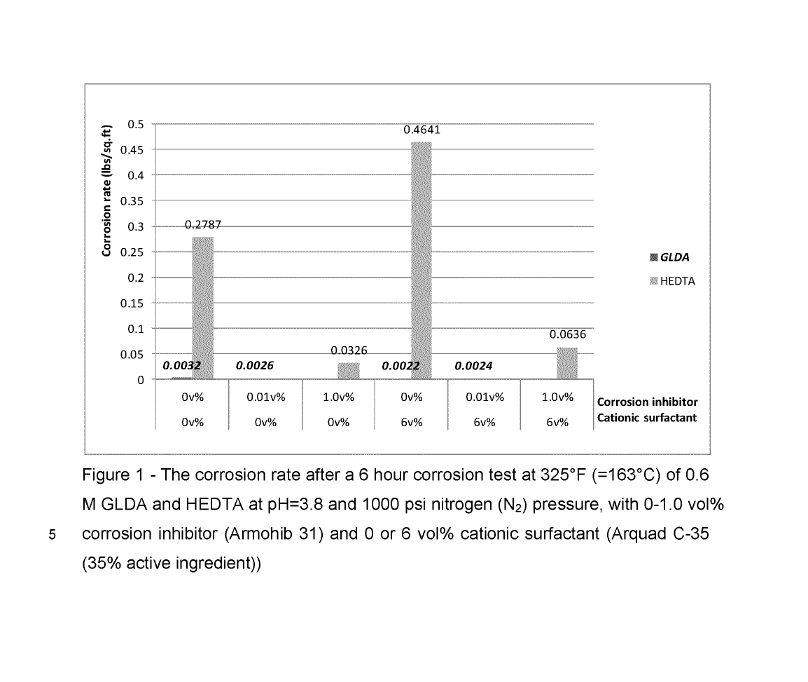

To study the effect of the combination of a corrosion inhibitor, cationic surfactant, and GLDA on the corrosion of Cr-13 steel (UNS S41000), a series of corrosion tests were performed using the method described in Example 1. The results expressed as the 6-hour metal loss at 325° F. are shown in FIG. 1. The cationic surfactant, Arquad C-35, consists of 35% cocotrimethyl ammonium chloride and water. Armohib 31 represents a group of widely used corrosion inhibitors for the oil and gas industry and consists of alkoxylated fatty amine salts, alkoxylated organic acid, and N,N′-dibutyl thiourea. The corrosion inhibitor and cationic surfactant are available from AkzoNobel Surface Chemistry.

The results show that the corrosion rate of GLDA is significantly less than for HEDTA under all studied conditions. In combination with 0.01 vol % of corrosion inhibitor and/or 6 vol % of cationic surfactant the corrosion rate of GLDA remains well below the acceptable limit of 0.05 lbs/sq.ft. Even in the absence of corrosion inhibitor acceptable results were obtained for this type of metallurgy, but for inferior quality metal types a minor amount of corrosion inhibitor is expected to be needed. For HEDTA 1.0 vol % corrosion inhibitor is not yet sufficient to reduce the corrosion rate below this limit. The results show that, in contrast to HEDTA, GLDA is surprisingly gentle to Cr-13 metal and that combining GLDA with corrosion inhibitor or cationic surfactant or not does not influence the corrosion rate.

### EXAMPLE 3

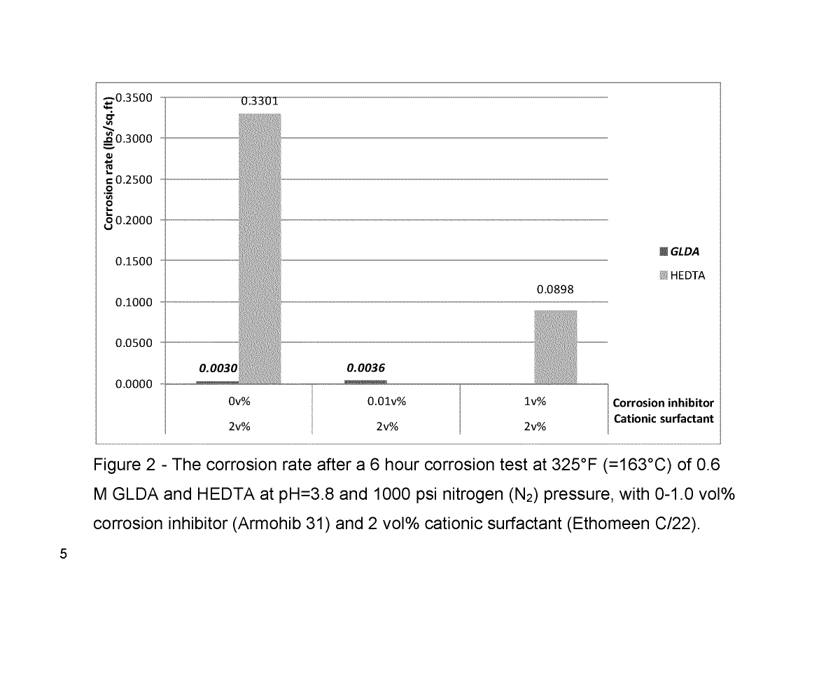

The corrosion experiment described in Example 2 was repeated with a different type of surfactant. Ethomeen C/22 is a cationic surfactant and consists of coco alkylamine ethoxylate with nearly 100% active ingredient and can be obtained from AkzoNobel Surface Chemistry. The results are shown in FIG. 2 and show the same trend as in FIG. 1. For HEDTA 1.0 vol % corrosion inhibitor is insufficient by far to reduce the corrosion rate below the generally accepted limit of 0.05 lbs/sq.ft. In contrast to HEDTA, GLDA in combination with this cationic surfactant is surprisingly gentle to Cr-13 steel.

### EXAMPLE 4

### General Procedure Coreflood Tests

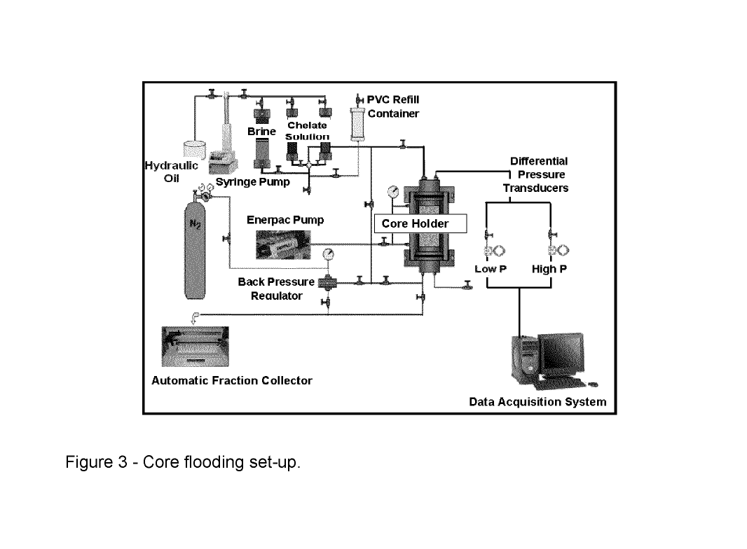

FIG. 3 shows a schematic diagram for the core flooding apparatus. For each core flooding test a new piece of core with a diameter of 1.5 inches and a length of 6 or 20 inches was used. The cores were placed in the coreholder and shrinkable seals were used to prevent any leakage between the holder and the core.

An Enerpac hand hydraulic pump was used to pump the brine or test fluid through the core and to apply the required overburden pressure. The temperature of the preheated test fluids was controlled by a compact bench top CSC32 series, with a 0.1° resolution and an accuracy of ±0.25% full scale±1° C. It uses a type K thermocouple and two Outputs (5 A 120 Vac SSR). A back pressure of 1,000 psi was applied to keep CO₂ in solution.

The back pressure was controlled by a Mity-Mite back pressure regulator model S91-W and kept constant at 300-400 psi less than the overburden pressure. The pressure drop across the core was measured with a set of FOXBORO differential pressure transducers, models IDP10-A26E21F-M1, and monitored by lab view software. Two gauges were installed with ranges of 0-300 psi and 0-1500 psi, respectively.

Before running a core flooding test, the core was first dried in an oven at 250° F. and weighted. Subsequently the core was saturated with water at a 1500 psi overburden pressure and 500 psi back pressure. The pore volume was calculated from the difference in weight of the dried and saturated core.

The core permeability before and after the treatment was calculated from the pressure drop using Darcy's equation for laminar, linear, and steady-state flow of Newtonian fluids in porous media:

K=(122.81qμL)/(ΔpD²)

where K is the core permeability, md, q is the flow rate, cm³/min, μ is the fluid viscosity, cP, L is the core length, in., Δp is the pressure drop across the core, psi, and D is the core diameter, in.

Prior to the core flooding tests the cores were pre-heated to the required tests temperature for at least 3 hours.

The effect of saturating Pink Desert Limestone cores with oil and water on the performance of GLDA was studied. A solution of 0.6M GLDA of pH 4 at 5 cm³/min and 300° F. was used in the core flooding experiments. The PV_{bt} was 4 PV in the water-saturated cores.

The core flooding experiments were repeated using oil-saturated cores with the same solution, giving again a PV_{bt} of 4 PV in the case of oil-saturated cores. This demonstrates that GLDA is similarly compatible with oil and with water.

### EXAMPLE 5

Using the same procedure as described in Example 4, the effect of saturating Indiana Limestone cores with oil was studied at 300° F. The cores were saturated first with water and then flushed with oil at 0.1 cm³/min, three pore volumes of oil were injected into the core, and after that the cores were left in the oven at 200° F. for 24 hours and 15 days.

The core flooding experiments for the Indiana cores saturated with oil at S_{wi} were performed by treating them with 0.6M GLDA at an injection rate of 2 cm³/min and 300° F. The Indiana core that was treated with 0.6M GLDA at pH 4 had a pore volume of 22 cm³ and the residual water after flushing the core with oil was 5 cm³ (S_{wi}=0.227). After soaking the core for 15 days and then flushing it with water at 300° F. and 2 cm³/min, only 6 cm³ of the oil was recovered and the volume of residual oil was 10 cm³ (Sₒᵣ=0.46); this is a high fraction of the pore volume indicating an oil-wet core. The pore volume to breakthrough (PV_{bt}) for the Indiana cores that were treated with GLDA was 3.65 PV for the water-saturated core, and 3.10 PV for the oil-saturated core. The presence of oil in the core reduced the PV_{bt} for the cores treated with 0.6M GLDA at pH of 4, thus the GLDA performance was enhanced in the oil-saturated cores by creating a dominant wormhole. The enhancement in the performance can be attributed to the reduced contact area exposed to the reaction with GLDA. 2D CT scan images showed that the wormhole diameter was not affected by saturating the core with oil or water.

This Example again demonstrates that GLDA is similarly compatible with oil and with water.

### EXAMPLE 6

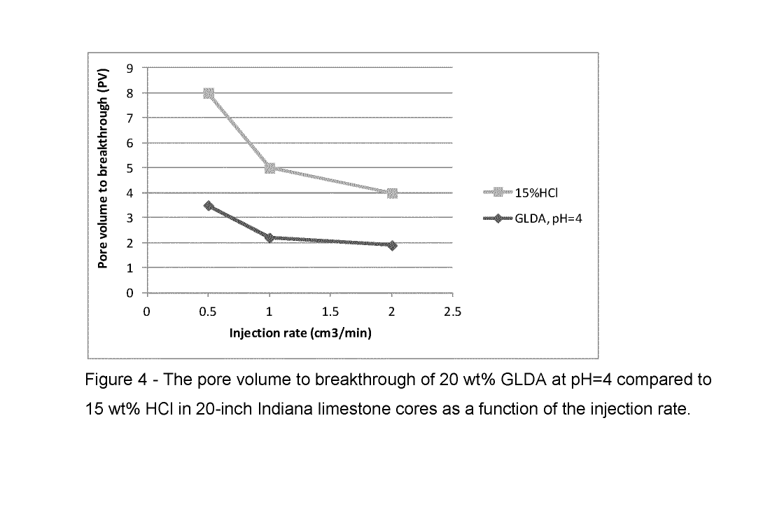

The procedure of Example 4 was used to compare the efficiency of 20 wt % GLDA at pH=4 with 15 wt % HCl in the stimulation of 20-inch Indiana limestone cores with an average initial permeability of 1 mD. As shown in FIG. 4, at 250° F. the pore volume to breakthrough required for GLDA is significantly smaller in comparison with HCl, showing the advantage of this new stimulation fluid in terms of chemical need, chemical cost, and environmental impact. At 0.5 and 1 cm³/min the HCl-treated core showed significant formation damage, as up to 2 inches of core were dissolved at the inlet side of the core.

### EXAMPLE 7

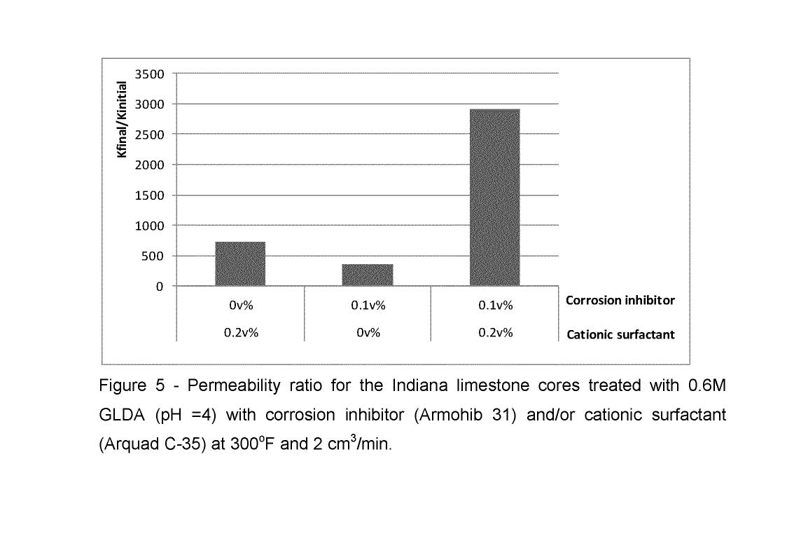

The core flooding procedure described in Example 4 was used to study the influence of the cationic surfactant and/or corrosion inhibitor on the performance of an acidizing treatment with 0.6M GLDA. Core flooding experiments with Indiana limestone with an initial permeability of 1 to 1.6 mD (milli Darcy) were carried out at 300° F. and an injection rate of 2 cm³/min. The cationic surfactant that was used was Arquad C-35 ex Akzo Nobel Surface Chemistry, the corrosion inhibitor that was used was Armohib 31 ex Akzo Nobel Surface Chemistry. Based on the results of Example 2, the fluids containing GLDA were made with 0.1% of corrosion inhibitor and with 0.2 vol % of cationic surfactant. Fluids containing HEDTA with 0.1% corrosion inhibitor both with cationic surfactant and without could not be used in the core flooding test, because these fluids were found to be so corrosive that they would damage the core flooding equipment. For similar reasons also no core flooding test could be performed with a fluid containing HCl with the same amounts of surfactant and corrosion inhibitor; this fluid was also found to be too corrosive. Visual inspection of the cores after treatment showed no face dissolution or wash-out in any of the cores. 2D CT scans show wormhole propagation throughout the entire length of the core for all treatments. The pore volumes needed to break through the cores were between 4.6 and 4.9 for all experiments. The results, expressed as the final permeability divided by the initial permeability measured in the opposite flow direction of the treatment fluids, to align with actual conditions in an oil or gas well, are shown in FIG. 5.

The permeability ratio is highest after treatment with a combination of GLDA and cationic surfactant plus corrosion inhibitor, showing a remarkably synergistic effect of combining these three components. In conclusion, combining GLDA with cationic surfactant and corrosion inhibitor gives significantly better results in improvement of the permeability than do fluids containing GLDA with either the surfactant or the corrosion inhibitor, and therefore a significant improvement in the production of the oil or gas well while simultaneously protecting the equipment against corrosion even under downhole conditions of high temperature and pressure.

1. Fluid suitable for treating carbonate formations comprising glutamic acid N,N-diacetic acid or a salt thereof (GLDA) and/or methylglycine N,N-diacetic acid or a salt thereof (MGDA), a corrosion inhibitor, and a surfactant.

2. Fluid of claim 1, wherein the amount of GLDA and/or MGDA is 5 to 30 wt % on the basis of the total weight of the fluid.

3. Fluid of claim 1 comprising GLDA.

4. Fluid of claim 1, wherein the corrosion inhibitor is present in an amount of 0.1-2 volume % on total fluid.

5. Fluid of claim 1, wherein the corrosion inhibitor is selected from the group consisting of amine compounds, quaternary ammonium compounds, and sulfur compounds.

6. Fluid of claim 1, wherein the surfactant is present in an amount of 0.1-2 volume % on total fluid.

7. Fluid of claim 1, wherein the surfactant is a nonionic or cationic surfactant.

8. Fluid of claim 1, wherein the surfactant is selected from the group consisting of quaternary ammonium compounds and derivatives thereof.

9. Fluid of claim 1, further comprising water as a solvent for the other components.

10. Fluid of claim 1, further comprising a biocide and/or a bactericide.

11. Fluid of claim 1, further comprising an additive selected from the group consisting of mutual solvents, anti-sludge agents, water-wetting or emulsifying surfactants, corrosion inhibitor intensifiers, foaming agents, viscosifiers, wetting agents, diverting agents, oxygen scavengers, carrier fluids, fluid loss additives, friction reducers, stabilizers, rheology modifiers, gelling agents, scale inhibitors, breakers, salts, brines, pH control additives, particulates, crosslinkers, salt substitutes, relative permeability modifiers, sulfide scavengers, fibres, and nanoparticles.

12. Fluid of claim 1 having a pH of from 3.5 to 13.

13. Kit of parts suitable for treating carbonate formations wherein one part comprises a fluid comprising glutamic acid N,N-diacetic acid or a salt thereof (GLDA) and/or methylglycine N,N-diacetic acid or a salt thereof (MGDA), and a corrosion inhibitor, and the other part comprises a fluid comprising a surfactant, and, optionally, a mutual solvent.

14. Kit of parts of claim 13, wherein the amount of GLDA and/or MGDA is 5 to 30 wt % on the basis of the total weight of the fluid in the one part.

15. Kit of parts of claim 13 comprising GLDA.

16. Kit of parts of claim 13, wherein the corrosion inhibitor is present in an amount of 0.1-2 volume % on total fluid in the one part.

17. Kit of parts of claim 13, wherein the corrosion inhibitor is selected from the group consisting of amine compounds, quaternary ammonium compounds, and sulfur compounds.

18. Kit of parts of claim 13, wherein the surfactant is present in an amount of 0.1-2 volume % on total fluid in the other part.

19. Kit of parts of claim 13, wherein the surfactant is a nonionic or cationic surfactant.

20. Kit of parts of claim 13, wherein the surfactant is selected from the group consisting of quaternary ammonium compounds and derivatives thereof.

21. Kit of parts of claim 13 further comprising water as a solvent for the other components.

22. Kit of parts of claim 13 further comprising a biocide and/or a bactericide.

23. Kit of parts of claim 13 further comprising an additive selected from the group consisting of mutual solvents, anti-sludge agents, water-wetting or emulsifying surfactants, corrosion inhibitor intensifiers, foaming agents, viscosifiers, wetting agents, diverting agents, oxygen scavengers, carrier fluids, fluid loss additives, friction reducers, stabilizers, rheology modifiers, gelling agents, scale inhibitors, breakers, salts, brines, pH control additives, particulates, crosslinkers, salt substitutes, relative permeability modifiers, sulfide scavengers, fibres, and nanoparticles.

24. Kit of parts of claim 13, wherein at least the fluid in the one part has a pH of from 3.5 to 13.

25. Process for treating a subterranean carbonate formation to increase the permeability thereof, remove small particles therefrom and/or remove inorganic scale therefrom, comprising introducing the fluid of claim 1 into the subterranean formation.

26. Process for cleaning a wellbore and/or descaling an oil/gas production well and production equipment in the production of oil and/or gas from a subterranean carbonate formation, comprising introducing the fluid of claim 1 into the wellbore, well or production equipment.

27. Process for treating a subterranean carbonate formation to increase the permeability thereof, remove small particles therefrom and/or remove inorganic scale therefrom, comprising introducing the kit of parts of claim 12 into the subterranean formation, wherein the one part is introduced into the carbonate formation for the main treatment step and the other part for the preflush and/or postflush step.

28. Process for cleaning a wellbore and/or descaling an oil/gas production well and production equipment in the production of oil and/or gas from a subterranean carbonate formation comprising introducing the kit of parts of claim 13 into the wellbore, well or production equipment.
